(19) United States
(12) Patent Application Publication
(10) Pub. No.: US 2021/0033172 A1
(43) Pub. Date: Feb. 4, 2021

(54) DRIVING MODULE AND TRANSMISSION SYSTEM

(71) Applicant: ABILITY ENTERPRISE CO., LTD., New Taipei City (TW)

(72) Inventors: Chang-Hsiao CHI, Taipei City (TW); Cheng-Kuang TSENG, New Taipei City (TW); Yung-Tseng YEN, New Taipei City (TW)

(21) Appl. No.: 16/941,221

(22) Filed: Jul. 28, 2020

(30) Foreign Application Priority Data
Jul. 30, 2019 (TW) 108209988

(51) Int. Cl. F16H 7/02

(52) U.S. Cl. CPC F16H 7/02

(57) ABSTRACT

A driving module and a transmission system are provided. The driving module includes a fixing portion, a motor and a holder. The fixing portion has a first opening. The motor has a first rotating wheel. The holder has a second opening. The first rotating wheel passes through the second opening and the first opening.

This application claims the benefit of Taiwan application Serial No. 108209988, filed Jul. 30, 2019, the disclosure of which is incorporated by reference herein in its entirety.

### TECHNICAL FIELD

The prevent invention relates in general to a driving module and a transmission system, and more particularly to a driving module and a transmission system including a motor.

### BACKGROUND

The transmission system is widely used in daily life to utilize mechanical energy to achieve the demand for power transmission. The transmission system usually includes a driving module as the main power source. A common driving module includes a motor, and the job of such a transmission system is to transmit the power output by the motor to another module to be driven. However, the traditional driving module and transmission system still have defects that need to be improved so as to improve transmission performance while saving costs.

### SUMMARY

The prevent invention is directed to a driving module and a transmission system to improve the aforementioned defects.

According to one aspect, a driving module is provided. The driving module includes a fixing portion, a motor and a holder. The fixing portion has a first opening. The motor has a first rotating wheel. The holder has a second opening. The first rotating wheel passes through the second opening and the first opening.

According to another aspect, a driving module is provided. The driving module includes a fixing portion, a motor and a holder. The motor corresponds to the fixing portion. The holder is disposed between the fixing portion and the motor, and fixed to the motor. There is a gap between an end surface of the fixing portion and an end surface of the holder.

According to still another aspect, a transmission system is provided. The transmission system includes a driving module, a driven module and a transmission belt. The driving module includes a fixing portion, a motor and a holder. The fixing portion has a first opening. The holder has a second opening. The motor has a first rotating wheel. The first rotating wheel passes through the second opening and the first opening. The driven module has a second rotating wheel. The transmission belt is disposed on the first rotating wheel and the second rotating wheel.

In order to have a better understanding of the above and other aspects of the present invention, in the following description, specific examples and detailed descriptions in conjunction with the attached drawings are as follows.

### BRIEF DESCRIPTION OF THE DRAWINGS

FIG. 1 shows a three-dimensional view of a driving module according to one embodiment of the present invention.

FIG. 2 shows a three-dimensional view of a transmission system according to one embodiment of the present invention.

FIG. 3 shows an exploded drawing of the transmission system of FIG. 2.

FIG. 4 shows a cross-sectional view in a stereo perspective of a part of the transmission system of FIG. 2 taken along the cross-sectional line 4-4′.

FIG. 5 and FIG. 6 are schematic diagrams illustrating the steps of adjusting the tension of the transmission belt.

FIG. 7 shows a side view of the part of the transmission system of FIG. 6.

### DETAILED DESCRIPTION

In the following description, a plurality of implementations of the present invention will be disclosed with the drawings. For the sake of clarity, many practical details will be described in the following description. However, it should be understood that these practical details should not be used to limit the present invention. That is to say, in a part of the implementations of the present invention, these practical details are unnecessary. In addition, in order to simplify the drawings, some conventional structures and elements will be shown in a simple schematic manner in the drawings. Moreover, unless otherwise indication, the same element symbol in different drawings may be regarded as a corresponding element. These drawings are for clearly expressing the connection relationship between the elements in these implementations, not to show the actual size of the elements.

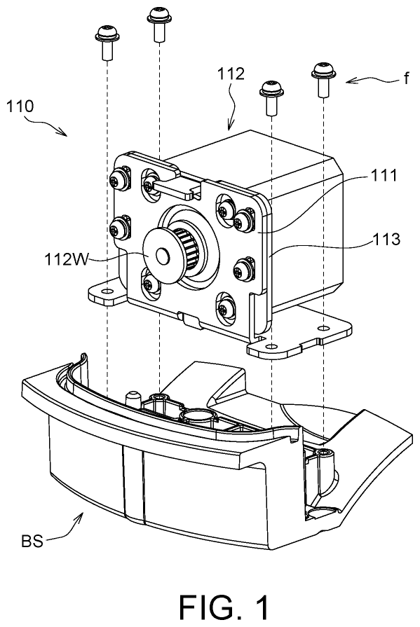

Referring to FIG. 1, a three-dimensional view of a driving module 110 according to one embodiment of the present invention is shown. The driving module 110 includes a fixing portion 111, a motor 112 and a holder 113. The driving module 110 may be fixed to a base BS of one device, for example, through the screws f. In some specific embodiments, the driving module 110 is fixed to the base BS with the fixing portion 111.

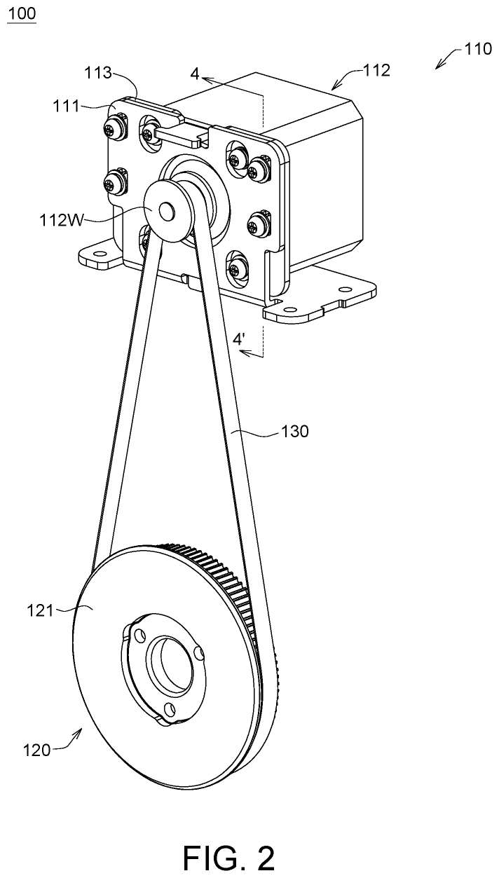

FIG. 2 shows a three-dimensional view of a transmission system 100 according to one embodiment of the present invention. In FIG. 2 and the subsequent drawings, the base BS of FIG. 1 is omitted in order to clearly show the structure of the transmission system 100.

Referring to FIG. 2, the transmission system 100 includes a driving module 110, a driven module 120 and a transmission belt 130. The motor 112 of the driving module 110 has a first rotating wheel 112W, and the driven module 120 has a second rotating wheel 121. The first rotating wheel 112W serves as a driving wheel, and the second rotating wheel 121 serves as a driven wheel. The transmission belt 130 is disposed on the first rotating wheel 112W and the second rotating wheel 121. Specifically, a plurality of teeth (not shown) are provided on the surface of the transmission belt 130 and may engage with the first rotating wheel 112W and the second rotating wheel 121 respectively. When the first rotating wheel 112W as the driving wheel is driven to rotate, the first rotating wheel 112W turns the transmission belt 130, and then the transmission belt 130 drives the second rotating wheel 121 to rotate.

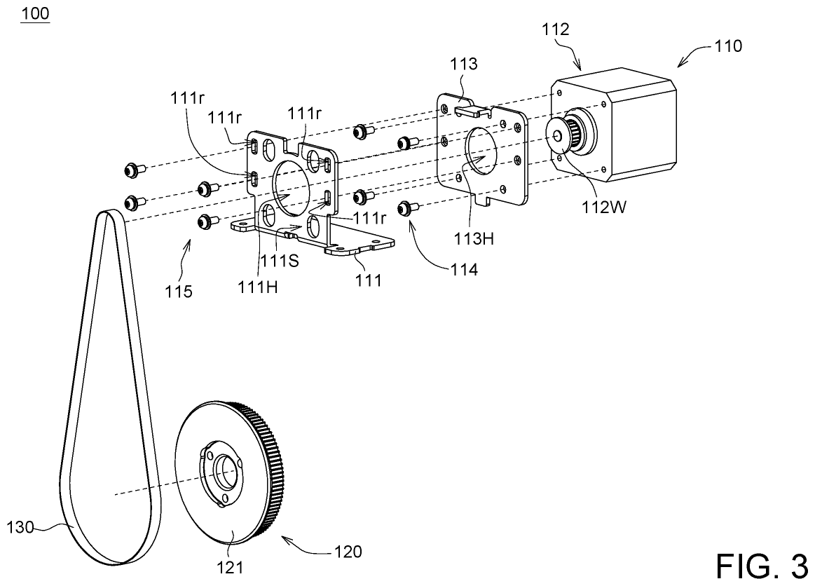

FIG. 3 shows an exploded drawing of the transmission system 100 of FIG. 2. Referring to FIG. 2 and FIG. 3, the fixing portion 111, the motor 112 and the holder 113 are correspondingly arranged. Specifically, the fixing portion 111 has a first opening 111H, and the holder 113 has a second opening 113H. The first rotating wheel 112W of the motor 112 passes through the second opening 113H and the first opening 111H to engage with the transmission belt 130.

Referring to FIG. 3, after the first rotating wheel 112W of the motor 112 passes through the second opening 113H of the holder 113, the motor 112 is fixed to the holder 113. The motor 112 and the holder 113 may be fixed to each other by the screws 114, but the present invention is not limited thereto.

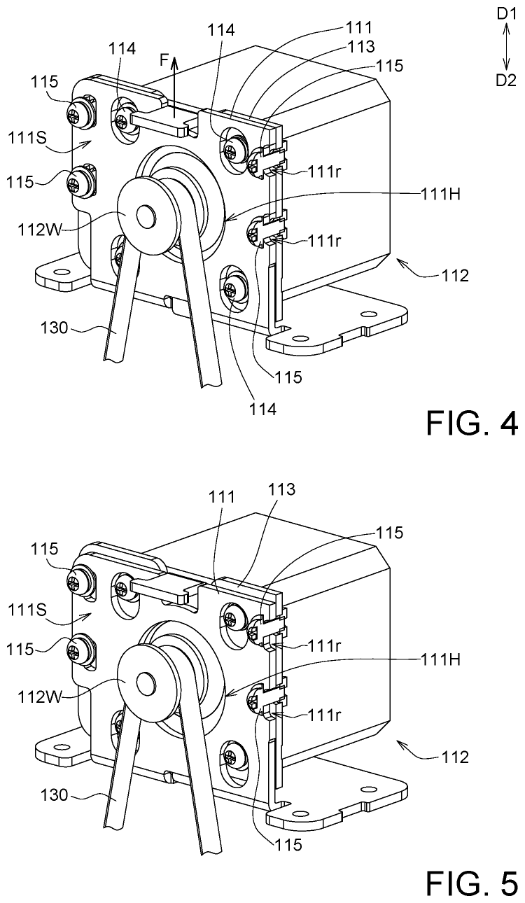

FIG. 4 shows a cross-sectional view in a stereo perspective of a part of the transmission system 100 of FIG. 2 taken along the cross-sectional line 4-4′. Referring to FIG. 3 and FIG. 4, the driving module 110 may further include a connection element 115. In some specific embodiments, the connection element 115 may be screws, but the present invention is not limited thereto. After the motor 112 is fixed to the holder 113, the first rotating wheel 112W of the motor 112 may further pass through the first opening 111H of the fixing portion 111. Next, after the fixing portion 111 is fixed to the base BS (as shown in FIG. 1), the connection element 115 may pass through a slot 111r of the fixing portion 111 therefore to be fixed to the holder 113.

In the state as shown in FIG. 4, the connection element 115 does not tightly press onto the surface 111S of the fixing portion 111, but assumes a half-locked state. That is, the current connection element 115 is only screwed to the holder 113 but not screwed to the fixing portion 111 yet. Therefore, under such a state, the holder 113 may move relative to the fixing portion 111. For example, the holder 113 may move away from the second rotating wheel 121 in a first direction D1, or move closer to the second rotating wheel 121 in a second direction D2, but the present invention is not limited to these directions.

When the holder 113 moves relative to the fixing portion 111, the motor 112 and its first rotating wheel 112W may also move synchronously. Since the first rotating wheel 112W and the transmission belt 130 engage with each other, a gap between the first rotating wheel 112W and the second rotating wheel 121 will be changed as the first rotating wheel 112W moves. In this manner, the tension of the transmission belt 130 may be adjusted.

Furthermore, when the first rotating wheel 112W moves a distance relative to the first opening 111H of the fixing portion 111 in the first direction D1, the tension of the transmission 130 may be increased. When the first rotating wheel 112W moves a distance relative to the first opening 111H of the fixing portion 111 in the second direction D2, the tension of the transmission 130 may be lowered. Under such a configuration, the tension may be adjusted according to the tightness of the transmission belt 130 itself and the design requirement.

In practice, each transmission belt 130 may be provided with different elastic coefficients and lengths, and after assembly, the motor 112, the driven module 120 and the transmission belt 130 of each transmission system 100 must achieve a consistent or preset velocity. Therefore, during the assembly of the transmission system 100, the holder 113 may move relative to the fixing portion 111. That is, there is a gap d1 between an end surface 111t of the fixing portion 111 and an end surface 113t of the holder 113 (denoted in FIG. 7), so that the distance between the first rotating wheel 112W of the motor 112 and the second rotating wheel 121 may be changed and the tension of the transmission belt 130 reaches a desired value. After that, the holder 113 and the fixing portion 111 are fastened. In other words, the gap between the end surface of the fixing portion 111 and the end surface of the holder 113 of each transmission system 100 may be set according to the tension of the transmission belt 130.

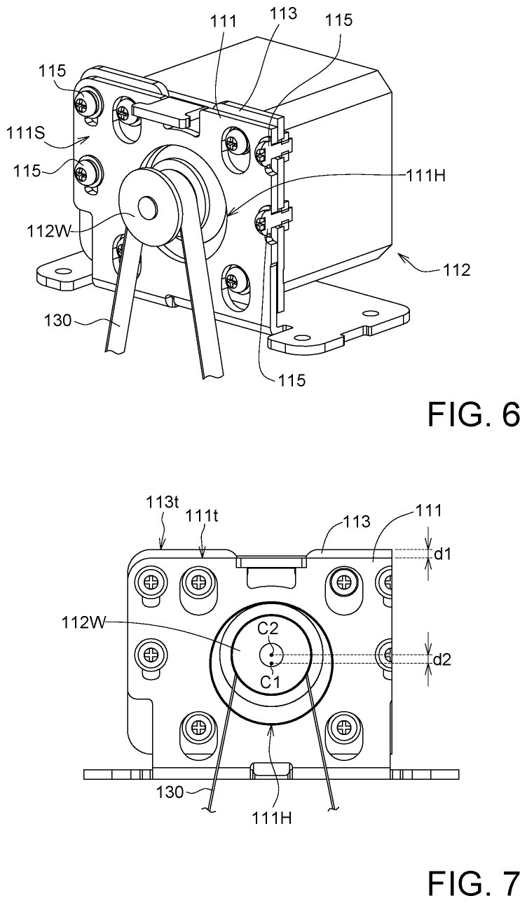

FIG. 5 and FIG. 6 are schematic diagrams illustrating the steps of adjusting the tension of the transmission belt 130. Referring to FIG. 4, FIG. 5 and FIG. 6, for example, if it is desired to increase the tension of the transmission belt 130, a rated load F may be applied to the holder 113 to move the holder 113 and the motor 112 in the first direction D1. As shown in FIG. 4 and FIG. 5, at this time, the connection element 115 moves relative to the slot 111r in the first direction D1, and the first rotating wheel 112W also moves relative to the first opening 111H in the first direction D1.

Referring to FIG. 6, when the desired tension of the transmission belt 130 is reached, the connection element 115 may be tightly pressed onto the surface 111S of the fixing portion 111, so that the locking portion 111 and the holder 113 are fixed to each other by the connection element 115.

FIG. 7 shows a side view of the part of the transmission system 100 of FIG. 6. Referring to FIG. 4 and FIG. 7, there is a gap d1 between the end surface 111t of the fixing portion 111 and the end surface 113t of the holder 113. Specifically, the end surface 111t of the fixing portion 111 and the end surface 113t of the holder 113 may respectively be defined as the surfaces of the fixing portion 111 and the holder 113 on the side away from the second rotating wheel 121. Since the holder 113 may move relative to the fixing portion 111 in the first direction D1 or the second direction D2 so as to adjust the tension of the transmission belt 130, the value of the gap d1 is variable.

Specifically, the constraint between the fixing portion 111 and the holder 113 may be loosened first according to requirement. After the tension of the transmission belt 130 is adjusted to a desired value, the fixing portion 111 and the holder 113 are fastened.

In some specific embodiments, the value of the gap d1 may be greater than or equal to zero. For example, in one condition, when the tension of the transmission belt 130 has not been adjusted, the end surface 111t of the fixing portion 111 and the end surface 113t of the holder 113 may be aligned with each other, as shown in FIG. 4. Under such a condition, the value of the gap d1 is equal to zero. In FIG. 7, when the holder 113 moves relative to the fixing portion 111 in the first direction D1, the end surface 113t of the holder 113 is offset from the end surface 111t of the fixing portion 111. Under such a condition, the value of the gap d1 is greater than zero.

Referring to FIG. 4 and FIG. 7, the first opening 111H of the fixing portion 111 has a center C1, and the first rotating wheel 112W of the motor 112 has a center of circle C2. There is a distance d2 between the center C1 of the first opening 111H and the center of circle C2 of the first rotating wheel 112W. Since the first rotating wheel 112W may move relative to the first opening 111H in the first direction D1 or the second direction D2 so as to adjust the tension of the transmission belt 130, the value of the distance d2 will change accordingly.

In some specific embodiments, the value of the distance d2 may be greater than or equal to zero. For example, in one condition as shown in FIG. 4, when the tension of the transmission belt 130 has not been adjusted, the center C1 of the first opening 111H may be aligned with the center of circle C2 of the first rotating wheel 112W, and therefore the value of the distance d2 is equal to zero. In one condition as shown in FIG. 7, when the first rotating wheel 112W moves relative to the first opening 111H in the first direction D1, the center C1 of the first opening 111H is offset from the center of circle C2 of the first rotating wheel 112W. Under such a condition, the value of the distance d2 is greater than zero.

Briefly, as long as the holder 113 moves relative to the fixing portion 111 so that the distance between the first rotating wheel 112W and the second rotating wheel 121 is changed, the tension of the transmission belt 130 may be adjusted.

It will be apparent to those skilled in the art that various modifications and variations can be made to the disclosed embodiments. It is intended that the specification and examples be considered as exemplary only, with a true scope of the prevent invention being indicated by the following claims and their equivalents.

What is claimed is:

1. A driving module comprising:
a fixing portion having a first opening;
a motor having a first rotating wheel; and
a holder having a second opening, the first rotating wheel passing through the second opening and the first opening.

2. The driving module according to claim 1, wherein the motor and the holder are fixing, and a gap is between an end surface of the fixing portion and an end surface of the holder.

3. The driving module according to claim 2, wherein a value of the gap is greater than or equal to zero.

4. The driving module according to claim 1, wherein a distance is between a center of the first opening and a center of circle of the first rotating wheel.

5. The driving module according to claim 4, wherein a value of the distance is greater than or equal to zero.

6. A transmission system comprising the driving module according to claim 4, a second rotating wheel and a transmission belt, the transmission belt disposing on the first rotating wheel and the second rotating wheel, and the distance coming from the tension of the transmission belt.

7. A transmission system comprising the driving module according to claim 1, a second rotating wheel and a transmission belt, the transmission belt disposing on the first rotating wheel and the second rotating wheel, a gap present between an end surface of the fixing portion and an end surface of the holder according to the tension of the transmission belt.

8. A driving module comprising:
a holder;
a motor having a first rotating wheel, the motor and the holder are fixing; and
a fixing portion attaching to the holder and disposing opposite to the motor, a gap present between an end surface of the fixing portion and an end surface of the holder.

9. The driving module according to claim 8, wherein a value of the gap is greater than or equal to zero.

10. A transmission system comprising the driving module according to claim 8, a second rotating wheel and a transmission belt, the transmission belt disposing on the first rotating wheel and the second rotating wheel.

11. The driving module according to claim 10, wherein the gap comes from the tension of the transmission belt.

12. A transmission system comprising:
a driving module having a fixing portion, a motor and a holder, the holder disposing between the fixing portion and the motor, the motor fixing to the holder, and the motor having a first rotating wheel;
a driven module having a second rotating wheel; and
a transmission belt disposing on the first rotating wheel and the second rotating wheel.

13. The transmission system according to claim 12, wherein the fixing portion has a first opening, the holder has a second opening, and the first rotating wheel passes through the second opening and the first opening.

14. The transmission system according to claim 13, wherein a distance is between a center of the first opening and a center of circle of the first rotating wheel.

15. The transmission system according to claim 14, wherein the distance comes from the tension of the transmission belt.

16. The transmission system according to claim 12, wherein a gap is between an end surface of the fixing portion and an end surface of the holder.

17. The transmission system according to claim 16, wherein the gap comes from the tension of the transmission belt.
